(19) United States
(12) Patent Application Publication
(10) Pub. No.: US 2010/0017649 A1
(43) Pub. Date: Jan. 21, 2010

(54) Data storage system with wear-leveling algorithm

(75) Inventors: Gary Wu, Fremont, CA (US); Roger Chin, San Jose, CA (US)

Correspondence Address: TUNG & ASSOCIATES / RANDY W. TUNG, ESQ., 838 W. LONG LAKE RD., SUITE 120, BLOOMFIELD HILLS, MI, 48302, US

(73) Assignee: Nanostar Corporation

(21) Appl. No.: 12/218,949

(22) Filed: Jul. 19, 2008

(51) Int. Cl. G06F 11/07; G06F 12/00

(52) U.S. Cl. 714/6; 711/114; 714/48; 711/154; 711/E12.001; 714/E11.025

(57) ABSTRACT

The present invention discloses a data storage system employing a plurality of electrical memory devices, preferably non-volatile memory cards or sub-modules, whereby user data or application software codes or OS software codes are protected by RAID (redundant array of inexpensive disks) architecture, and wear-leveling algorithms are uniquely arranged to extend the life cycles of such data storage system.

### BACKGROUND

1. Field of The Invention

The present invention relates to a data storage system with unique wear-leveling algorithm. The data storage system preferably includes non-volatile memory cards or sub-modules in RAID architecture. The present invention also relates to a data storage method.

2. Description of Related Art

A flash memory system is a system including one or more non-volatile memory units; a memory unit includes a number of memory cells, e.g., 64K, 128K, 256K, etc. An example of such flash memory system is the non-volatile memory card. Non-volatile memory cards are memory cards made by non-volatile memory devices such as, but not limited to, Flash EEPROM, Nitride based non-volatile memory, SONOS (Silicon Oxide Nitride Oxide Silicon), Non-volatile FeRAM (Ferroelectric Random Access Memory), Non-volatile MRAM (Magneto-resistive Random Access Memory), PCRAM (Phase Change Random Access Memory), Perovskite (CaTiO3, Calcium Titanium Oxide), etc. Such memory cards include, but are not limited to, USB flash drive, card bus card, SD flash card, MMC flash card, memory stick, MI card, Expresscard flash card, solid state drive with SATA-II interface, etc.

These types of semiconductor based (solid state) mass storage devices are slower in read/write operations and have significantly lower memory densities than the well known mechanically driven magnetic storage devices. However, they are extremely rugged, highly reliable and highly efficient as compared to those mechanically driven magnetic storage devices.

In recent years, a RAID (redundant array of inexpensive disks) technology has been proposed to improve the data reliability of the mechanically driven magnetic storage devices. For reference, U.S. Pat. Nos. 5,680,579; 6,467,022; 6,513,093; 7,200,715 and 7,334,156 disclose inventions relating to RAID.

In accordance with RAID, a plurality of magnetic media disks are assembled in an array and through a hardware/software interface, presents itself to a host system as a single logical disk drive. A hardware based RAID system employs dedicated electronic circuitry to perform the processing functions of the RAID system. A software based RAID system employs hardware and software which locates processing functions of the RAID system on the host CPU (central processing unit). RAID is used as an architecture for the mechanically driven magnetic storage devices to minimize the risk of data loss.

While the individual drives in a RAID system are still subject to the same failure rates, RAID significantly improves the overall reliability by providing one or more redundant arrays; in this way, data is available even if one of the drives fails.

Redundancy is a method of storing redundant data on drives within the array, so that with the failure of a single drive, the data from the failed disk can be reconstructed using the redundant data from the other operating drives. This mathematical technique of storing redundant data is well known and is referred to as parity, which typically uses an exclusive OR function, and is an important feature of RAID.

A RAID Advisory Board has been established whereby standard RAID configurations are being defined as industry standards. By way of example, RAID-0 has disks with data stripped across the drives. Stripping is a known method of quickly storing blocks of data across a number of different drives. With RAID-0 each drive is read independently and there is no redundancy. Accordingly, the RAID-0 configuration improves speed performance but does not increase data reliability, as compared to individual drives. RAID-1 defines a configuration where data is written in identical form, or mirrored onto two or more drives. With this configuration many drives are required and therefore it is not an economical solution to data reliability. RAID-2 utilizes complex ECC (error correction codes) codes written on multiple redundant disks. RAID-3 incorporates redundancy using a single disk drive to support the extra memory needed for parity, which is shared among all of the drives. This configuration is commonly used where high transfer rates are required and/or long blocks of data are used. The other disk drives (i.e., other than the parity drive) in the RAID-3 configuration operate on every I/O (input/output) transaction handled by the array, i.e., parallel access. RAID-4 is similar to RAID-3 in that it also uses interleaved parity; however unlike RAID-3, RAID-4 uses block-interleaved parity and not bit-interleaved parity. Accordingly, RAID-4 defines a parallel array using block striping and a single redundant parity disk. The RAID-5 configuration has parity shared across all drives in the array. However, in the RAID-5 configuration the disks are independent, i.e., independent access, which is used with many I/O request as it can more rapidly handle concurrent I/O transactions. The RAID-5 configuration is used with multi-user networked workstations. The RAID-6 configuration includes striped set with dual distributed parity. RAID-6 provides fault tolerance from two drive failures; array continues to operate with up to two failed drives. This makes larger RAID groups more practical, especially for high availability systems. This becomes increasingly important because large-capacity drives lengthen the time needed to recover from the failure of a single drive. Single parity RAID levels are vulnerable to data loss until the failed drive is rebuilt: the larger the drive, the longer the rebuild will take. Dual parity gives time to rebuild the array without the data being at risk if one drive, but no more, fails before the rebuild is complete.

Although RAID has been used to improve the data reliability of the mechanically driven magnetic storage devices, sophisticated RAID architecture has not been used in non-volatile memory cards because non-volatile memory cards are believed highly reliable and highly efficient. Moreover, non-volatile memory cards have not been used as primary storage devices in personal computer, notebook, or similar electronic apparatuses.

On the other hand, although non-volatile memory or, more specifically, non-volatile memory storage cells within a flash memory system may be repetitively programmed and erased, each cell or physical location may only be erased a certain number of times before the cell wears out. When a cell is worn out, thereby causing a loss of use or a significant degradation of performance to a portion of the overall storage volume of the flash memory system, a user of the flash memory system may be adversely affected, as for example through the loss of stored data or the inability to store data.

The wear on cells, or physical locations, within a flash memory system varies depending upon how often each of the cells is programmed. If a cell is programmed once and then effectively never reprogrammed, the wear associated with that cell will generally be relatively low. However, if a cell is repetitively written to and erased, the wear associated with that cell will generally be relatively high. As logical addresses are used by a host, e.g., a system which accesses or uses a flash memory system, to access data stored in a flash memory system, if a host repeatedly uses the same logical addresses to write and overwrite data, the same physical locations or cells within the flash memory system are repeatedly written to and erased, as will be appreciated by those of skill in the art.

When some cells are effectively worn out while other cells are relatively unworn, in addition to degradation of performance associated with worn out cells themselves, the overall performance of the flash memory system will be adversely affected. Often, a flash memory system is deemed unusable when a critical number of worn out cells are present in the flash memory system, even when many other cells in the flash memory system are relatively unworn.

In order to increase the likelihood that cells within a flash memory system are worn fairly evenly, a so-called “wear-leveling” technology has been proposed. Wear-leveling is an operation performed within a memory integrated circuit or a memory card to allow the cells which are associated with particular logical addresses to be changed such that the same logical addresses are not always associated with the same cells. By changing the cell associations of logical addresses, it is less likely that a particular cell may wear out well before other cells wear out.

However, so far “wear-leveling” is applied only within a storage device, such as in a memory integrated circuit or in a memory card, but not at the system level. With respect to data storage systems which include multiple memory devices, there has not been any prior art discussing how to improve the endurance of the overall system. Thus, it is desirous to provide a data storage system with wear leveling from system perspective, to prolong its lifetime.

### SUMMARY OF THE INVENTION

In view of the foregoing drawback, it is therefore an objective of the present invention to provide a data storage system with unique wear-leveling algorithm. The above-discussed and other drawbacks and deficiencies of the prior art are overcome or alleviated by the present invention. The data storage system preferably uses non-volatile memory cards or sub-modules in RAID architecture.

Another objective of the present invention is to provide electrical memory devices arranged according to RAID architecture. In accordance with the present invention, RAID technology type architecture is uniquely combined with solid state non-volatile memory devices. Any of the aforementioned RAID type configurations (e.g., RAID-0 through 6) may be employed with the solid state memory devices.

Another objective of the present invention is to provide a data storage method.

In accordance with the foregoing and other objectives of the present invention, and from one aspect of the present invention, a data storage system is proposed which comprises: a plurality of user data memory devices for storing user data; a redundant memory device; a dedicated memory device for storing operating system software; and an interface and RAID controller electrically connected with the plurality of user data memory devices, the redundant memory device, and the dedicated memory device, and storing the user data in and reading the user data from the plurality of user data memory devices according to RAID configuration.

From another aspect of the present invention, a data storage method is proposed which comprises: storing user data in a plurality of user data memory devices according to RAID configuration; and when a user data memory device is at fault, recovering the correct data to a redundant memory device.

From yet another aspect of the present invention, a data storage system comprises: a plurality of memory devices; and a RAID controller electrically connected with the plurality of memory devices memory devices, and periodically setting at least a different one of the plurality of memory devices as a redundant memory device.

From a still other aspect of the present invention, a data storage system comprises: a first memory device of a longer endurance, such as an SLC (single-level cell) memory card; a plurality of second memory device of a shorter endurance, such as an MLC (multi-level cell) memory card; and a RAID controller electrically connected with the first and second memory devices. Preferably, the RAID controller periodically sets at least a different one of the plurality of memory devices as a redundant memory device.

From a further aspect of the present invention, a data storage method comprises: providing a plurality of memory regions; defining at least one of the plurality of memory regions to be unused when writing data in a time period; and defining at least another one of the plurality of memory regions to be unused when writing data in a subsequent time period.

From a still further aspect of the present invention, a data storage method comprises: providing a plurality of memory regions; checking the written times of each of the plurality of memory regions; moving the data in the memory region which has been written the most times to the presently unused memory region which has been written the fewest times among the presently unused memory regions; and moving the data in the memory region which has been written the fewest times to the memory region which has been written the most times.

From a still further aspect of the present invention, a data storage method comprises: providing a plurality of memory regions; checking the written times of each of the plurality of memory regions; and swapping the data in the memory region which has been written the most times with the data in the memory region which has been written the fewest times.

Preferably, each of the plurality of memory regions in the methods described above includes memory spaces in at least two memory cards.

More preferably, the methods described above further comprise: checking whether wear-leveling is implemented inside the memory cards.

It is to be understood that both the foregoing general description and the following detailed description are provided as examples, for illustration rather than limiting the scope of the invention.

### BRIEF DESCRIPTION OF THE DRAWINGS

These and other features, aspects, and advantages of the present invention will become better understood with regard to the following description, appended claims, and accompanying drawings.

FIG. 1 is a schematic diagram showing a data storage system according to a first embodiment of the present invention.

FIG. 2 is a schematic diagram showing a data storage system according to a second embodiment of the present invention.

FIG. 3 shows a preferred arrangement according to the present invention in which the memory regions are defined across the memory cards.

FIG. 4 shows a data shifting method for unique wear-leveling according to a method embodiment of the present invention.

FIG. 5 shows a data hopping method for unique wear-leveling according to another embodiment of the present invention.

FIG. 6 shows a data swapping method for unique wear-leveling according to a further embodiment of the present invention.

FIGS. 7A-7C are flowcharts showing two preferred embodiments of the present invention to combine the data shifting, hopping and swapping methods.

FIG. 8 shows a RAID level wear-leveling arrangement of the present invention.

FIG. 9 shows a RAID level wear-leveling arrangement of the present invention for a storage system which employs mixed kinds of memory devices, i.e, an SLC (Single-Level Cell) memory card and multiple MLC (Multi-Level Cell) memory cards in this example. The SLC card is used in all 4 T, but each MLC card is used in 3 out of 4 T.

FIG. 10 shows another RAID level wear-leveling arrangement of the present invention for a storage system which employs mixed kinds of memory devices. In this case, there are two hot spare cards; the SLC cards is used in all 5 T, but each MLC card is used in 3 out of 5 T.

### DESCRIPTION OF THE PREFERRED EMBODIMENTS

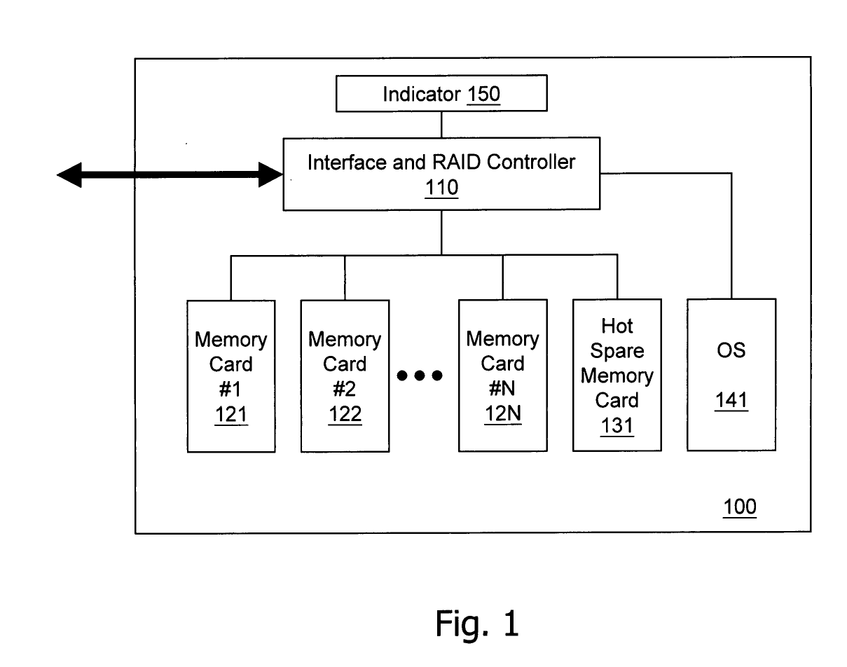

FIG. 1 is a schematic diagram showing a data storage system 100 according to a first embodiment of the present invention. The data storage system 100 for example is used as the primary data storage system of a personal computer, a notebook computer, or other similar electronic apparatuses; in other words, no “hard disk” is required in such electronic apparatuses. In case of a notebook computer, the data storage system 100 can be a SATA-II SSD (solid state disk) box communicating under SATA-II protocol, for example, or an Expresscard SSD drive communicating under PCIe protocol, as another example. As shown in the figure, the data storage system 100 includes an interface and RAID controller 110, a plurality of memory cards 121-12N where N is an integer larger than or equal to 3, a hot spare memory card 131, and an OS memory card 141 which stores operating system software, since the data storage system 100 is the primary data storage system. Optionally, the data storage system 100 can further include an indicator 150 to indicate whether any of the memory cards 121-12N is functioning normally. The memory cards 121-12N, 131 and 141 are preferably non-volatile memory cards, but can be other types of electrical memory devices as well. For example, the memory cards 121-12N, 131 and 141 can all be USB flash drives. The indicator 150 can be a number of LEDs.

The OS memory card 141 stores operating system software and operates in “pass-through” mode, i.e., the content in the OS memory card 141 simply passes through the interface and RAID controller 110 without being subject to RAID control. The plurality of memory cards 121-12N stores application software, user data and other information in “RAID” mode, i.e., the content of these memory cards 121-12N are stored according to RAID configuration, any type from RAID-0 to RAID-6, under the control by the interface and RAID controller 110. The interface and RAID controller 110 communicates with external circuits (shown by the thick black arrow) according to agreed protocol, such as SATA-II, PCIe, etc. It receives data from the external circuits and store the data into the memory cards 121-12N according to a predetermined RAID configuration, which can be any type from RAID-0 to RAID-6 set as a default, or selected by a user.

In addition to these memory cards 121-12N and 141, a redundant hot spare memory card 131 is provided. Whenever one of the memory cards 121-12N in RAID mode is at fault that can not be corrected by its own ECC circuit (not shown), a “self-rebuilding” function is performed to recover the correct data to the hot spare memory card 131. This self-rebuilding function can be done inside the data storage system 100 without interrupting the overcall operation of the electronic apparatus, since the operating system is not stored in one of the cards in RAID mode. Once self-rebuilding is finished, preferably, the indicator 150 indicates the at-fault card so that a user can replace the failed card with a new one.

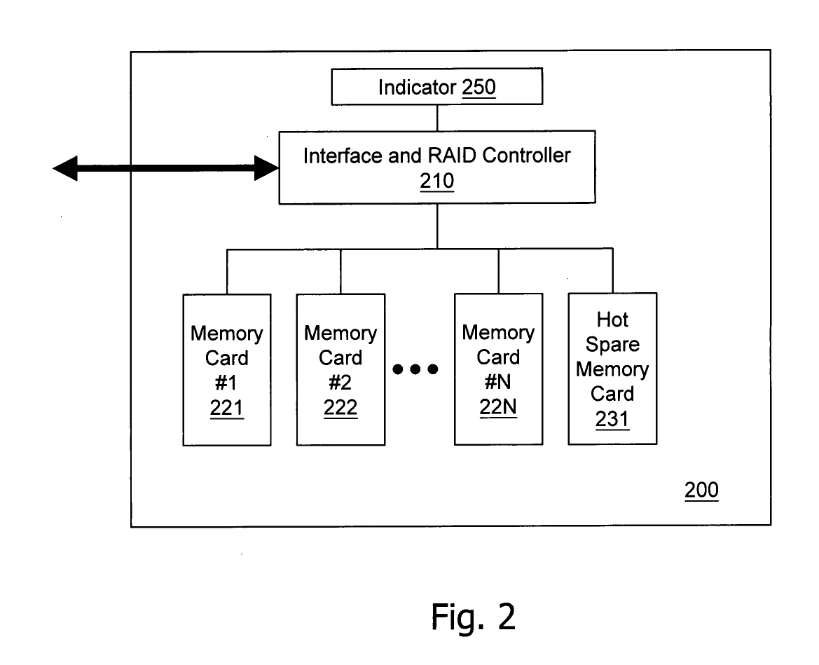

FIG. 2 is a schematic diagram showing a data storage system 200 according to a second embodiment of the present invention. In this embodiment, the data storage system 200 includes an interface and RAID controller 210, a plurality of memory cards 221-22N where N is an integer larger than or equal to 3, a hot spare memory card 231, and an indicator 250. These devices operate in a manner similar to that in the first embodiment, except that the data storage system 200 is not used as the primary data storage system for an electronic apparatus, so there is not a dedicated OS memory card for storing the operating system software. The electronic apparatus operates based on operating system supplied from another device. In this embodiment, the self-rebuilding function can also be achieved without interrupting the overall operation of the electronic apparatus.

Based on the system structure of FIG. 1 or 2, a unique wear-leveling arrangement can be implemented. In one embodiment, a first level in-card wear-leveling arrangement is implemented inside each flash memory card; a second level wear-leveling is implemented across all available memory cards. In another embodiment, the second level wear-leveling is implemented without the first level wear-leveling.

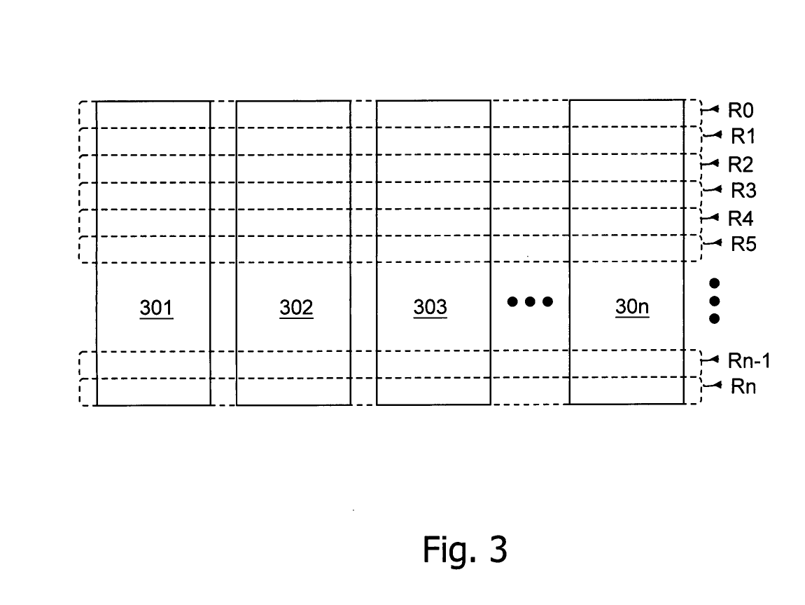

In the unique wear-leveling according to the present invention, all available memory spaces (e.g., blocks) are divided into regions. “Available” in this context means that a memory space is identified as usable and should be subject to second level wear-leveling. For example, it may be arranged either way that the OS memory card 141 is or is not available. FIG. 3 shows a preferred arrangement in which the memory regions R0-Rn are defined across the memory cards 301-30n, so that, preferably, one memory region includes memory spaces in multiple memory cards. Of course, the present invention is not limited to this arrangement; other arrangements are possible, such as, that one memory region includes memory spaces only in one memory card.

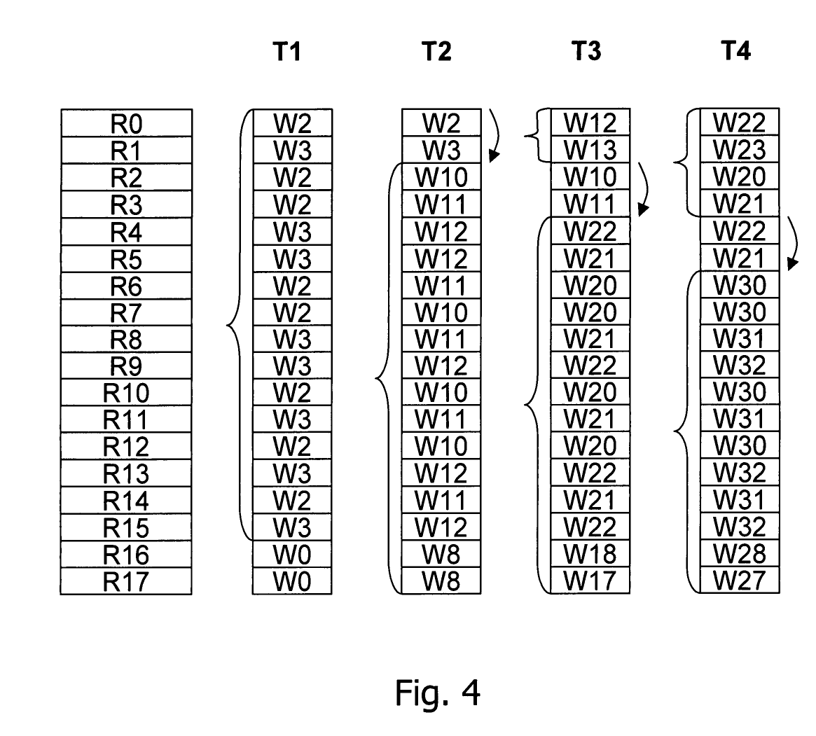

Referring to FIG. 4, in this example, all available memory spaces are divided into 18 memory regions R0-R17, including 16 active memory regions and two reserved memory regions. FIG. 4 shows the data shifting method according to one embodiment of the present invention. During time period T1, data are written into the first 16 memory regions R0-R15, but the last two memory regions R16 and R17 are reserved. W2 and W3 mean that the memory regions R0-R15 are each written two or three times, and W0 means that the memory regions R16 and R17 are written zero time. In the time period T2, the reserved memory regions shift to the regions R0 and R1, so data are written into the 16 memory regions R3-R17, while the first two memory regions R0 and R1 are written zero time in this period. Likely, the reserved memory regions shift to the regions R2 and R3 in the time period T3, and to the regions R4 and R5 in the time period T4, and so on. Thus, the work load is evenly distributed over all the memory regions. In the beginning of T2, the old data at R0 and R1 need to be moved to R16 and R17. The address index of the old data at R0 and R1 are changed to R16 and R17 accordingly. The address of old data at R2-R15 was shifted to new address of R0-R13 so that the old data at R2-R15 do not need to be moved. This way the overhead of wear leveling can be reduced. In the beginning of other T, the address table should preferably be updated as mentioned above.

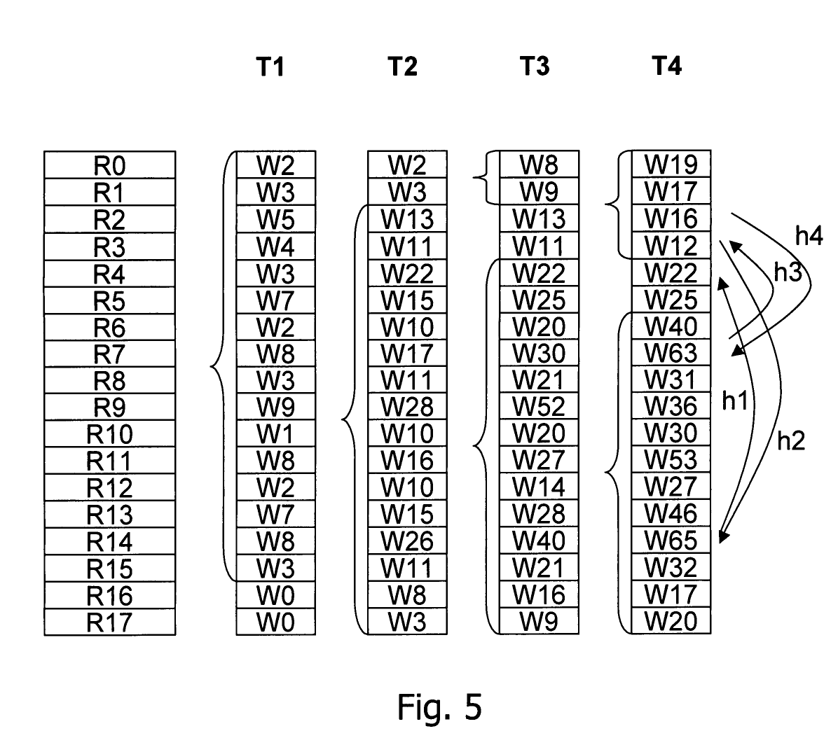

FIG. 5 shows the data hopping method according to another embodiment of the present invention. The data hopping method may be used alone or in combination with the data shifting method. Referring to the figure, assuming it is found that certain memory space is used too often as compared with others, for example after several periods of data shifting, a data hopping process is taken. In this example, after four periods of data shifting, it is found that the region R14 has been written 65 times, far more than many other regions. This implies that the data in this region is used more often than others. Hence, the data in the region R14 is moved to the less written region R4 (W22) of the two reserved regions, as shown by the arrow h1. Of course, this step should preferably be done after confirming that the data in the region R4 is not currently valid, which should be the case because the region R4 is a reserved region. The data in the region R4 can be temporarily stored in, e.g., a volatile memory associated with the storage system, or simply discarded. Next, the data in the region R3 (W12) is moved to the region R14, as shown by the arrow h2, because the region R3 is written the fewest times, implying that the data in the region R3 is used less often. Further next, the data in the region R7 (W63) is moved to the region R3, as shown by the arrow h3. And next, the data in the region R2 (W16) is moved to the region R7, as shown by the arrow h4. Such shifting step may repeat a fixed number of times, or until a predetermined requirement is met, for example, after all the more often used data have been moved. At last, the data originally in the region R4 can be stored back to the space which is left by the last move, or the data shifting method simply ends at the last move. After all the data are moved, preferably, the address table of those data is updated accordingly.

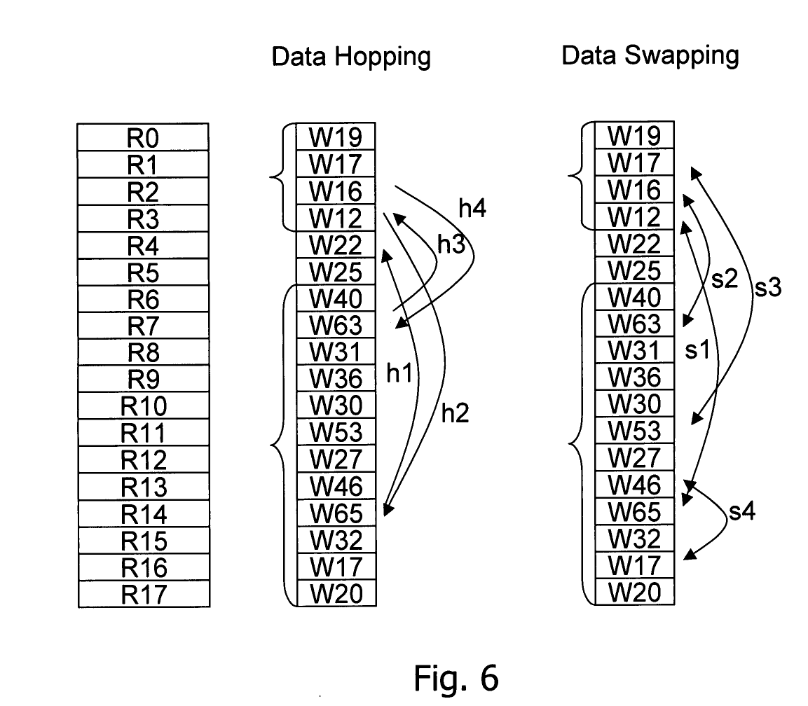

FIG. 6 shows the data swapping method according to a further embodiment of the present invention. The data swapping method may be used alone or in combination with one or both of the data shifting method and the data hopping method. The figure also shows the data hopping process at the left side for comparison. Referring to the right side of the figure, in the swapping method, the data in the region R14 (W65) is swapped with the data in the region R3 (W12) which is written the fewest times, as shown by the arrow s1. Similarly, the data in the region R7 (W63) is swapped with the data in the region R2 (W16), as shown by the arrow s2. More swapping steps are taken as required, as the arrows s3 and s4. The swapping step may repeat a fixed number of times, or until a predetermined requirement is met, for example, after all the more often used data have been moved. After all the data are moved, preferably, the address table of those data is updated accordingly.

To perform the data shifting, hopping or swapping method as above, preferably, an address mapping table should be maintained and updated after data movement is done. The data shifting method is more effective for serial data; the data hopping method is more effective for random data; the data swapping method is more effective for swapping long-live data with frequently written data. In one embodiment, the data swapping method may be initiated whenever the written times difference between two regions has reached a predetermined threshold, implying that one of which stores long-live data and the other of which stores frequently written data.

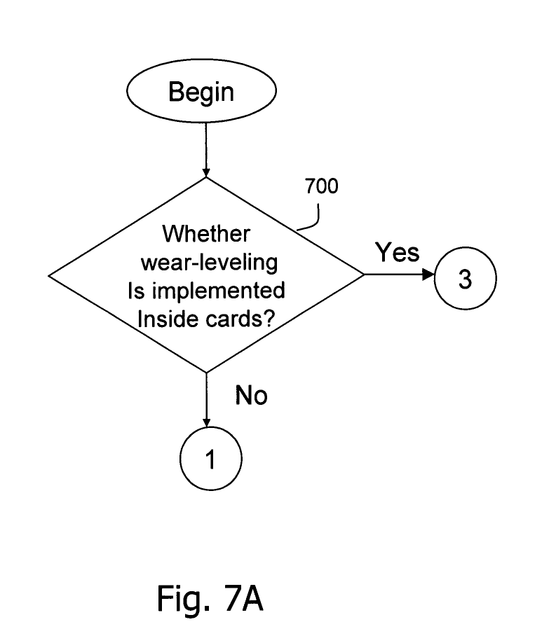

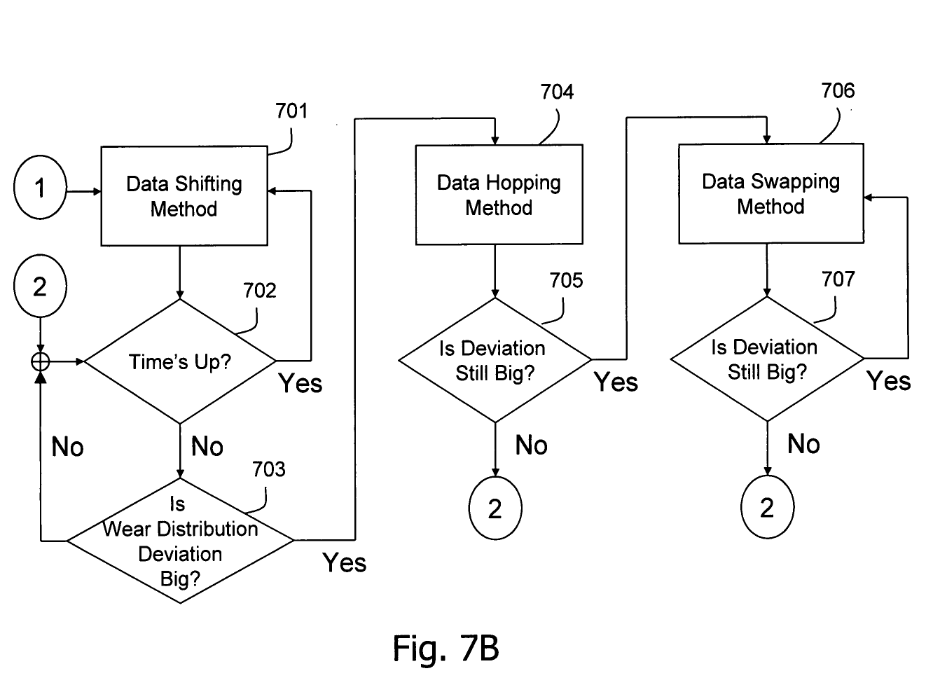

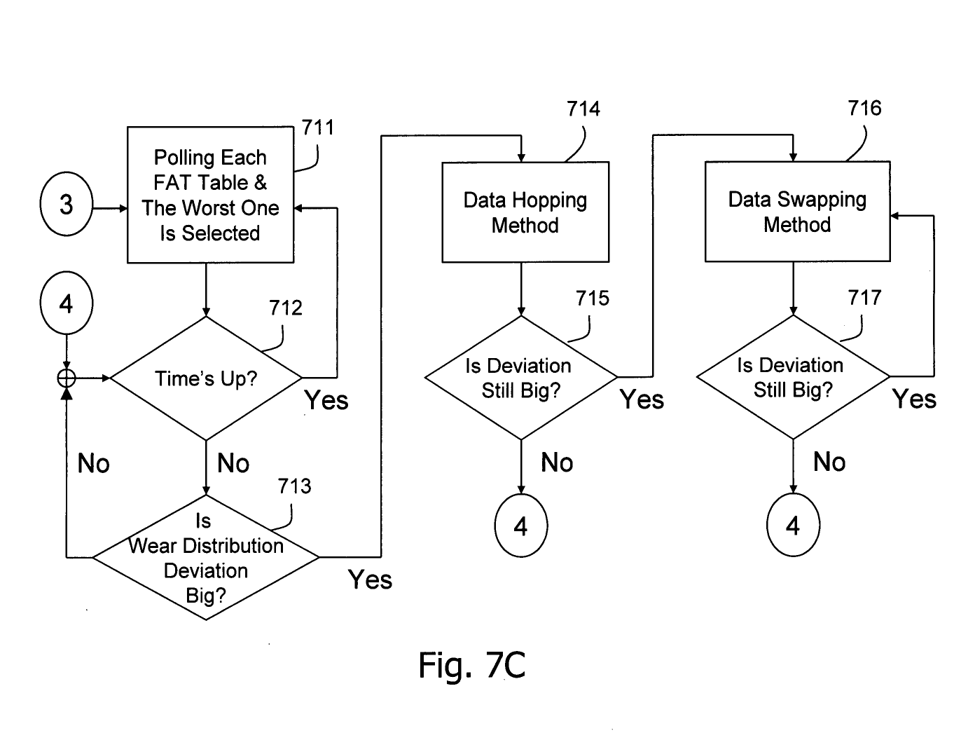

As described above, each of the data shifting method, the data hopping method and the data swapping method may be used alone or in combination with one or both of the other methods. FIG. 7B is a flowchart showing one preferred embodiment to combine the three methods. Referring to the figure, the system first performs a data shifting step 701. Then, if a predetermined period of time has not been reached (step 702), the system checks whether there is a big wear distribution deviation (step 703), that is, whether a memory space (e.g., a memory block) has been written many times, much more than another memory space, so that the written times difference between the two memory spaces is larger than a predetermined threshold. If not, the process goes back to the step 702. If yes, the process goes to the step 704, wherein the system performs data hopping. Next, the system checks whether there is still a big wear distribution deviation (step 705). If not, the process goes back to the step 702. If yes, the process goes to the step 706, wherein the system performs data swapping. Next, the system checks whether there is still a big wear distribution deviation (step 707). If yes, the system performs data hopping once more, until there is no big wear distribution deviation, and the process goes back to the step 702. In the step 702, if the predetermined period of time is reached, the process goes back to the step 701 and the system performs data shifting once more.

FIGS. 7B and 7C, together with 7A, show another preferred embodiment according to the present invention. Referring to FIG. 7A, in this embodiment, the system first checks whether wear-leveling is implemented inside the memory cards (step 700). If no, the process goes to step 701 in FIG. 7B and the steps described in the previous paragraph are taken; if yes, the process goes to step 711 in FIG. 7C. In FIG. 7C, The FAT table (File Allocation Table) in each card is polled in turn, and the table with the worst deviation is selected (step 711). This can be determined by, e.g., an accumulated number of the written times differences between several most deviated memory spaces in an FAT table. Then, if a predetermined period of time has not been reached (step 712), the system checks whether there is a big wear distribution deviation (step 713), that is, whether the written times difference between the two most deviated memory spaces is larger than a predetermined threshold. If not, the process goes back to the step 712. If yes, the process goes to the step 714, wherein the system performs data hopping. Next, the system checks whether there is still a big wear distribution deviation (step 715). If not, the process goes back to the step 712. If yes, the process goes to the step 716, wherein the system performs data swapping. Next, the system checks whether there is still a big wear distribution deviation (step 717). If yes, the system performs data hopping once more, until there is no big wear distribution deviation, and the process goes back to the step 712. In the step 712, if the predetermined period of time is reached, the process goes back to the step 711 and the system performs the step 711 once more.

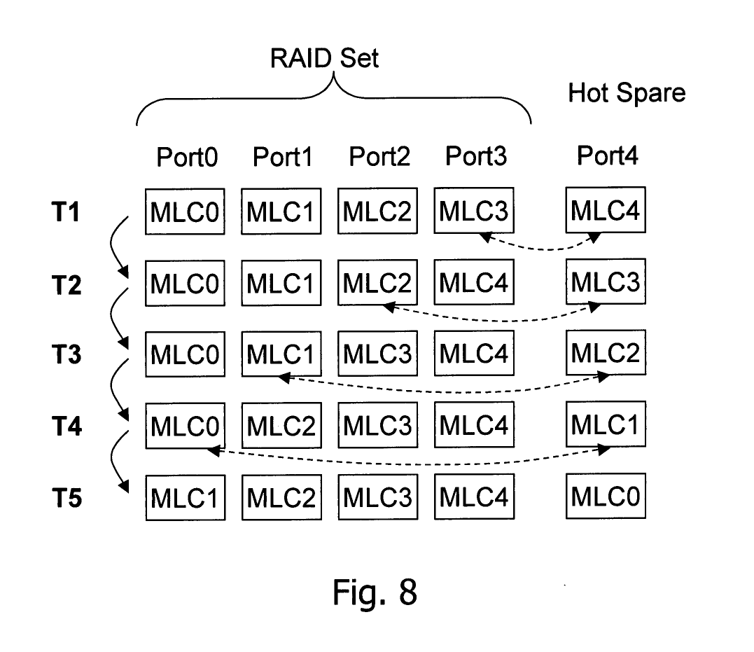

FIG. 8 shows a RAID level wear-leveling arrangement according to the present invention, which employs a “hot spare switching” technique. In this example, the storage system uses MLC cards MLC0-MLC4, one of which being a hot spare card and the rest of which construct a RAID set. As shown in the figure, after a period of time, the hot spare card switches from MLC4 to MLC3, to MLC2, to MLC1, and to MLC0. This hot spare switching arrangement prolongs the life time of the whole storage system because each MLC card is used only ⅘ of the time. Note that the switching does not require exchanging the physical locations of two memory cards; it can be done by the software in the RAID controller 110 or 210 (FIG. 1 or 2). And of course, before switching, the data in the RAID set memory card should be copied to the hot spare card to preserve the data. In summary, at time T1, MLC4 card and MLC3 card was swapped; at time T2, MLC3 card and MLC2 card was swapped; at time T3, MLC2 card and MLC1 card was swapped; at time T4, MLC1 card and MLC0 card was swapped; in the end, at time T5, the all set of MLC cards are utilized for 4 T out of 5 total T. So one hot spare MLC card reduce the usage of the four other cards by ⅕ T.

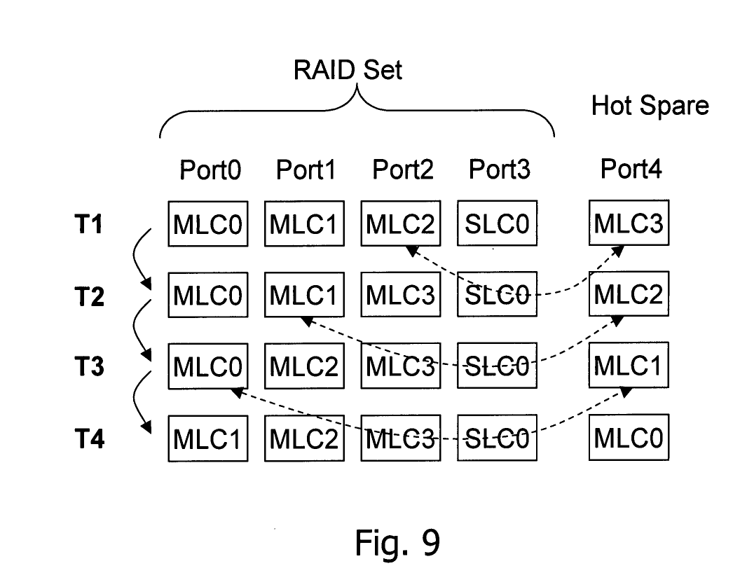

FIG. 9 shows a RAID level wear-leveling arrangement according to the present invention. This embodiment includes two features: hot spare switching and mixed mode architecture. More specifically, the system employs mixed kinds of memory devices, in this example one SLC memory card SLC0 and four MLC memory cards MLC0-MLC3. The SLC memory card SLC0 and three of the MLC memory cards construct a RAID set, while the fourth MLC memory card is used as a hot spare card. The system changes setting after a period of time so that the hot spare card switches from MLC3, to MLC2, to MLC1, and to MLC0. In this embodiment, only the SLC card SLC0 is used throughout four time periods T1-T4, while each of the MLC cards MLC0-MLC3 is used only in three of the four time periods T1-T4. This is because an SLC card has a longer life time (longer endurance) than an MLC card. This mixed-mode architecture, one SLC card and four MLC cards, further prolongs the life time of the whole storage system (wherein each MLC card is used only ¾ of the time), as compared with the case wherein there are five MLC memory cards with hot spare switching (wherein each MLC card is used ⅘ of the time).

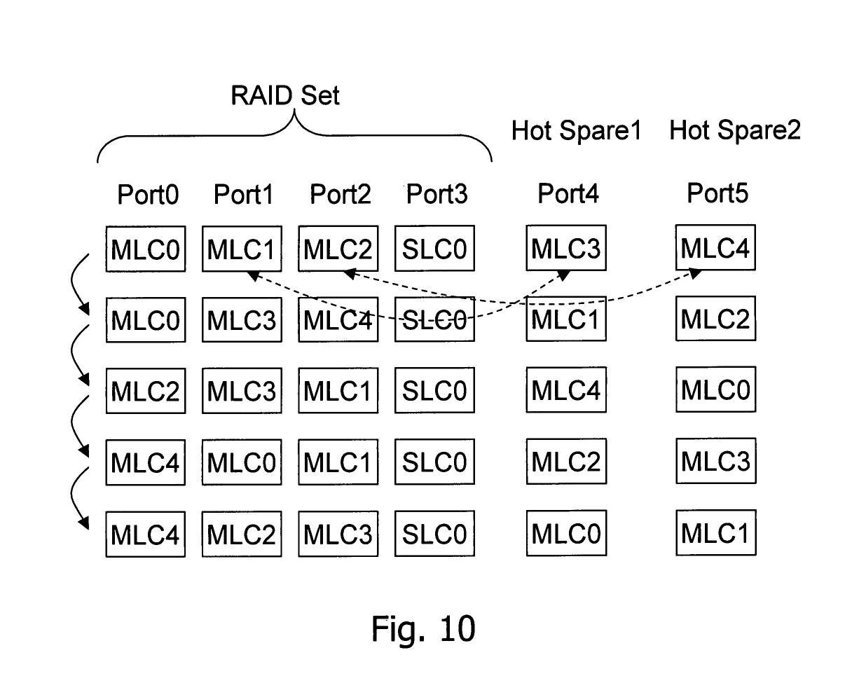

FIG. 10 shows another RAID level wear-leveling arrangement according to the present invention. In this embodiment, two hot spare cards are provided, so that each MLC card is used only ⅗ of the time. This embodiment also uses the mixed mode architecture.

Although the present invention has been described in detail with reference to certain preferred embodiment thereof, the description is for illustrative purpose, and not for limiting the scope of the invention. One skilled in this art can readily think of any modifications and variations in light of the teaching by the present invention. For example, in the arrangements shown in FIGS. 8 to 10, the memory cards can be X-3 (3 bits per cell) or X-4 (4 bits per cell) memory cards. (3 bits per cell or 4 bits per cell means that one memory cell stores data of 3 bits or 4 bits.) In view of the foregoing, it is intended that the present invention cover all such modifications and variations, which should interpreted to fall within the scope of the following claims and their equivalents.

What is claimed is:

1. A data storage system comprising:
a plurality of user data memory devices for storing user data;
a redundant memory device; and
an interface and RAID controller electrically connected with the plurality of user data memory devices, and the redundant memory device, and storing the user data in and reading the user data from the plurality of user data memory devices according to RAID configuration,
wherein the interface and RAID controller implements wear-leveling across the plurality of user data memory devices and the redundant memory device.

2. The data storage system of claim 1, wherein the interface and RAID controller further implements RAID-level wear-leveling by swapping at least one of the plurality of user data memory devices with the redundant memory device.

3. The data storage system of claim 1, wherein when a user data memory device is at fault, the interface and RAID controller recovers the correct data to the redundant memory device.

4. The data storage system of claim 1, further comprising: a dedicated memory device electrically connected with the interface and RAID controller for storing operating system software.

5. The data storage system of claim 1, further comprising: an indicator indicating a user data memory device which is at fault.

6. The data storage system of claim 1, wherein the interface and RAID controller stores the user data in and reading the user data from the plurality of user data memory devices according to RAID-0, RAID-1, RAID-2, RAID-3, RAID-4, RAID-5, RAID-6 configuration, or a combination configuration of any two or more of the above.

7. The data storage system claim 4, wherein the user data memory devices, the redundant memory device, and the dedicated memory device are one or more of the followings: USB flash drive, card bus card, SD flash card, MMC flash card, memory stick, MI card, Expresscard flash card, and solid state drive with SATA-II interface.

8. The data storage system claim 4, wherein the user data memory devices, the redundant memory device, and the dedicated memory device are one or more of the followings: Flash EEPROM, Nitride based non-volatile memory, SONOS (Silicon Oxide Nitride Oxide Silicon), Non-volatile FeRAM (Ferroelectric Random Access Memory), Non-volatile MRAM (Magneto-resistive Random Access Memory), PCRAM (Phase Change Random Access Memory), and Perovskite (CaTiO3, Calcium Titanium Oxide).

9. A data storage method comprising:
storing user data in a plurality of user data memory devices according to RAID configuration; and
when a user data memory device is at fault, recovering the correct data to a redundant memory device.

10. The method of claim 9, further comprising: storing operating system software in a dedicated memory device.

11. The method of claim 9, further comprising: indicating which user data memory device is at fault.

12. The method of claim 9, wherein the user data is stored according to RAID-0, RAID-1, RAID-2, RAID-3, RAID-4, RAID-5, RAID-6 configuration, or a combination configuration of any two or more of the above.

13. The method of claim 10, wherein the user data memory devices, the redundant memory device, and the dedicated memory device are one or more of the followings: USB flash drive, card bus card, SD flash card, MMC flash card, memory stick, MI card, Expresscard flash card, and solid state drive with SATA-II interface.

14. The method of claim 10, wherein the user data memory devices, the redundant memory device, and the dedicated memory device are one or more of the followings: Flash EEPROM, Nitride based non-volatile memory, SONOS (Silicon Oxide Nitride Oxide Silicon), Non-volatile FeRAM (Ferroelectric Random Access Memory), Non-volatile MRAM (Magneto-resistive Random Access Memory), PCRAM (Phase Change Random Access Memory), and Perovskite (CaTiO3, Calcium Titanium Oxide).

15. A data storage system comprising:
a plurality of memory devices; and
a RAID controller electrically connected with the plurality of memory devices memory devices, and periodically setting at least a different one of the plurality of memory devices as a redundant memory device.

16. A data storage system comprising:
a first memory device of a longer endurance;
a plurality of second memory device of a shorter endurance; and
a RAID controller electrically connected with the first and second memory devices.

17. The data storage system of claim 16, wherein the RAID controller periodically sets at least a different one of the plurality of second memory device as a redundant memory device.

18. The data storage system of claim 16, wherein the first memory device is a single-level cell memory card.

19. The data storage system of claim 16, wherein the second memory device is one selected from: multi-level cell memory card, tri-level cell memory card, and four-level memory card.

20. A data storage method comprising:
(a) providing a plurality of memory regions;
(b) defining at least one of the plurality of memory regions to be unused when writing data in a time period; and
(c) defining at least another one of the plurality of memory regions to be unused when writing data in a subsequent time period.

21. The method of claim 20, further comprising: repeating the steps (b) and (c) until all the plurality of memory regions have been defined unused at least once.

22. The method of claim 20, further comprising:
checking the written times of each of the plurality of memory regions;
moving the data in the memory region which has been written the most times to the presently unused memory region which has been written the fewest times among the presently unused memory regions; and
moving the data in the memory region which has been written the fewest times to the memory region which has been written the most times.

23. The method of claim 22, further comprising:
moving the data in the memory region which has been written the second most times to the memory region which has been written the fewest times; and
moving the data in the memory region which has been written the second fewest times to the memory region which has been written the second most times.

24. The method of claim 20, further comprising:
checking the written times of each of the plurality of memory regions; and
swapping the data in the memory region which has been written the most times with the data in the memory region which has been written the fewest times.

25. The method of claim 24, further comprising:
swapping the data in the memory region which has been written the second most times with the data in the memory region which has been written the second fewest times.

26. The method of claim 20, wherein each of the plurality of memory regions includes memory spaces in at least two memory cards.

27. The method of claim 26, further comprising: checking whether wear-leveling is implemented inside the memory cards.

28. A data storage method comprising:
providing a plurality of memory regions;
checking the written times of each of the plurality of memory regions;
moving the data in the memory region which has been written the most times to the presently unused memory region which has been written the fewest times among the presently unused memory regions; and
moving the data in the memory region which has been written the fewest times to the memory region which has been written the most times.

29. The method of claim 28, further comprising:
moving the data in the memory region which has been written the second most times to the memory region which has been written the fewest times; and
moving the data in the memory region which has been written the second fewest times to the memory region which has been written the second most times.

30. The method of claim 28, further comprising:
swapping the data in the memory region which has been written the most times with the data in the memory region which has been written the fewest times.

31. The method of claim 30, further comprising:
swapping the data in the memory region which has been written the second most times with the data in the memory region which has been written the second fewest times.

32. The method of claim 28, wherein each of the plurality of memory regions includes memory spaces in at least two memory cards.

33. The method of claim 32, further comprising: checking whether wear-leveling is implemented inside the memory cards.

34. A data storage method comprising:
providing a plurality of memory regions;
checking the written times of each of the plurality of memory regions; and
swapping the data in the memory region which has been written the most times with the data in the memory region which has been written the fewest times.

35. The method of claim 34, further comprising:
swapping the data in the memory region which has been written the second most times with the data in the memory region which has been written the second fewest times.

36. The method of claim 34, wherein each of the plurality of memory regions includes memory spaces in at least two memory cards.

37. The method of claim 36, further comprising: checking whether wear-leveling is implemented inside the memory cards.
